(19) United States
(12) Patent Application Publication
(10) Pub. No.: US 2006/0016126 A1
(43) Pub. Date: Jan. 26, 2006

(54) Peripheral planting system

(76) Inventor: Leroy Brorson, Dallas, TX (US)

Correspondence Address: Rudolf O. Siegesmund;Suite 2000, 4627 N. Central Expressway, Dallas, TX, 75205-4017, US

(21) Appl. No.: 10/897,630

(22) Filed: Jul. 23, 2004

(51) Int. Cl. A01G 9/02

(52) U.S. Cl. 47/86

(57) ABSTRACT

The present invention is a peripheral planting device (PPD). The PPD is circular in shape and rests on top of a flower pot containing a first plant. The PPD comprises a retaining clip, an outer wall, an inner wall, and a floor containing a plurality of holes. Alternatively, a semi-permeable material can be substituted for the floor and holes. The inner wall, outer wall, and floor create a U-shaped channel which contains a planting medium. At least one second plant may be planted in the planting medium in the U-shaped channel. The PPD may be a complete circle or may be comprised of several sections, which together can form a circle. The holes in the floor are sized such that excess water will pass through the holes and irrigate the planting medium in the pot, but the planting medium in the U-shaped will not pass through the holes.

### FIELD OF THE INVENTION

The present invention is directed generally to an apparatus for growing and irrigating plants and specifically to a combination planting and irrigation system for a plurality of plants.

### BACKGROUND OF THE INVENTION

Planters and flower pots are well known in the botanical arts. Typically, a gardener will plant a first plant in the center of the pot. The gardener may also want to add a plurality of second plants, such as flowers, to the pot to increase the aesthetic beauty of the first plant. One of the problems that gardeners face is that the second plants may be seasonal and need to be changed depending on the seasons. In order to accomplish this task, the gardener has to dig up the second plant, and plant the third plant in place of the second plant. The process of digging up the second plant and replanting the third plant can be very time consuming. Therefore, a need exists for an apparatus which allows a second plant to be easily exchanged with a third plant.

Separate planters for a second plant are known in the art. For example, U.S. Pat. No. 2,782,561 (the '561 patent) entitled “Tree Surrounding Ring” discloses a protecting ring in which a gardener may plant flowers. However, the '561 patent does not disclose an apparatus for planting a plurality of second plants in a flower pot. Additionally, the '561 patent does not disclose a method for securing the apparatus to the flower pot. Therefore, a need exists for an apparatus for planting a plurality of second plants which secures to a flower pot.

In addition, if a two planter arrangement is used to plant a first plant and a second plant, then the first plant has to be watered separately from the second plant. In watering the plants, it is preferable for the plants to receive watering over as much of the root area as possible. It is excessively time consuming for gardeners to water both the first plant and the second plant in a two plant arrangement. Therefore, a need exists for an apparatus which will water both a first plant and a second plant in a two planter arrangement.

Apparatuses for watering a first plant using a watering system are known in the art. For example, U.S. Pat. No. 4,067,143 (the '143 patent) entitled “Plant Watering Reminder” discloses an apparatus for watering a first plant. The '143 patent discloses an apparatus that utilizes a plurality of wicks to water the roots of a first plant. U.S. Pat. No. 5,097,626 (the '626 patent) entitled “Automatic Self-Watering System for Plants Growing in a Container” discloses an apparatus for watering a first plant. The '626 patent uses a moisture sensor to monitor the soil moisture and add water when necessary. U.S. Pat. No. 6,418,663 (the '663 patent) entitled “Potted Plant Watering Apparatus” discloses a watering system for a first plant. The '663 patent uses a wick system to deliver water to a first plant. What is missing in the '143 patent, the '626 patent, and the '663 patent is an apparatus for planting and watering both a first plant and second plant. Therefore, a need exists in the art for an apparatus for watering a plurality of second plants located around a first plant and wherein a gardener can water both the first plant and the second plant in one step.

Additionally, the prior art contains inventions to aid in the protection of plants. For example, U.S. Pat. No. 5,918,411 (the '411 patent) entitled “Plant Protector” discloses an apparatus for protecting the area at the base of a plant. The invention in the '411 patent retards weed growth and allows water captured within the invention to flow through holes in the bottom on the invention. However, the '411 patent fails to disclose an apparatus that secures to a pot. The '411 patent also fails to disclose an apparatus for planting a plurality of second plants around a first plant.

The prior art also contains inventions to aid in the protection of plants. For example, U.S. Pat. No. 5,839,222 (the '222 patent) entitled “Apparatus and Method for Increasing Plant Root Density and Measuring Plant Growth” discloses an apparatus for increasing the root density of a plant. The invention in the '222 patent increases the density of the fibrous root mass near the top of the planting medium. However, the '222 patent fails to disclose an apparatus that secures to a pot. The '222 patent also fails to disclose an apparatus for planting a plurality of second plants around a first plant.

Furthermore, the aesthetic beauty of floral and plant arrangements is very important to gardeners. Although gardeners attempt to increase the beauty of the arrangement with decorative pots, there is frequently a desire to conceal all or part of the pot. The gardener may want to conceal the pot because of the pot's lack of beauty or because the pot does not match the plants located in the pot. In cases where the pot does not match the plant, the gardener may attempt to make the visual coordination of the pot to the plant smoother by planting a second plant around the first plant. Therefore, a need exists for an apparatus which will simultaneously conceal a portion of the pot and allow for the planting of a plurality of second plants around the periphery of the first plant.

### SUMMARY OF THE INVENTION

The present invention, which meets the needs identified above, is a peripheral planting device (PPD). The PPD is circular in shape and rests on top of a flower pot or planter containing a first plant. The PPD comprises a retaining clip, an outer wall, an inner wall, and a floor containing a plurality of holes. Alternatively, a semi-permeable material can be substituted for the floor and holes. The inner wall, outer wall, and floor create a U-shaped channel which contains a planting medium. At least one second plant may be planted in the planting medium in the U-shaped channel. The PPD may be a complete circle or may be comprised of several sections, which together form a circle. If the PPD is made of sections, then each section has a partition on the open sides of the U-shaped channel to keep the planting medium in the PPD from falling out when one of the sections is removed. The holes in the floor are sized such that excess water will pass through the holes and irrigate the planting medium in the pot, but the planting medium in the U-shaped channel will not pass through the holes.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a perspective view of the present invention showing the first plant, the second plant, the pot, and the peripheral planting device;

FIG. 2 is a cross-sectional view of the peripheral planting device showing the retaining clip, the inner wall, the outer wall, and the floor with a plurality of holes;

FIG. 3 is a cross-sectional view of an alternative embodiment of the peripheral planting device showing the retaining clip, the inner wall, the outer wall, and the semi-permeable material;

FIG. 4 is an elevation view of the present invention showing the first plant, the second plant, the pot, and the peripheral planting device;

FIG. 5 is a plan view of the one-section embodiment of the present invention;

FIG. 6 is a plan view of the two-section embodiment of the present invention;

FIG. 7 is a plan view of the three-section embodiment of the present invention; and

FIG. 8 is a perspective view of a user exchanging one section of the peripheral planting device.

### DETAILED DESCRIPTION OF THE PREFERRED EMBODIMENT

As used herein, the term “planting medium” means a substance into which a first plant and/or a second plant are located. Examples of planting mediums are dirt and potting soil.

As used herein, the term “pot” means a planting device containing a first plant.

As used herein, the term “retaining clip” means a device for securing a peripheral planting system to a pot.

As used herein, the term “semi-permeable material” means a composition of matter that which is slightly porous so that smaller sized particles, such as water, flow through the material, but larger sized particles, such as pieces of planting medium, do not pass through the material.

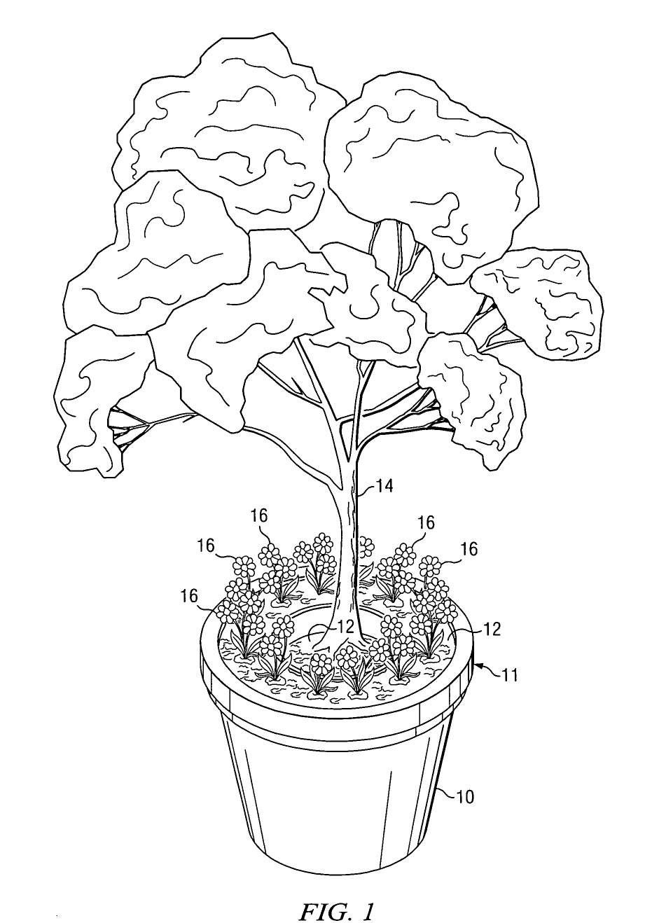

Turning to FIG. 1, a perspective view of the present invention is illustrated. Pot 10 is substantially cylindrical in shape and contains planting medium 12 and first plant 14. Peripheral planting device (PPD) 11 sits on the upper ridge of pot 10. PPD 11 contains planting medium 12 and a plurality of second plants 16. As seen in FIG. 1, PPD 11 surrounds first plant 14 along the peripheral edge of pot 10.

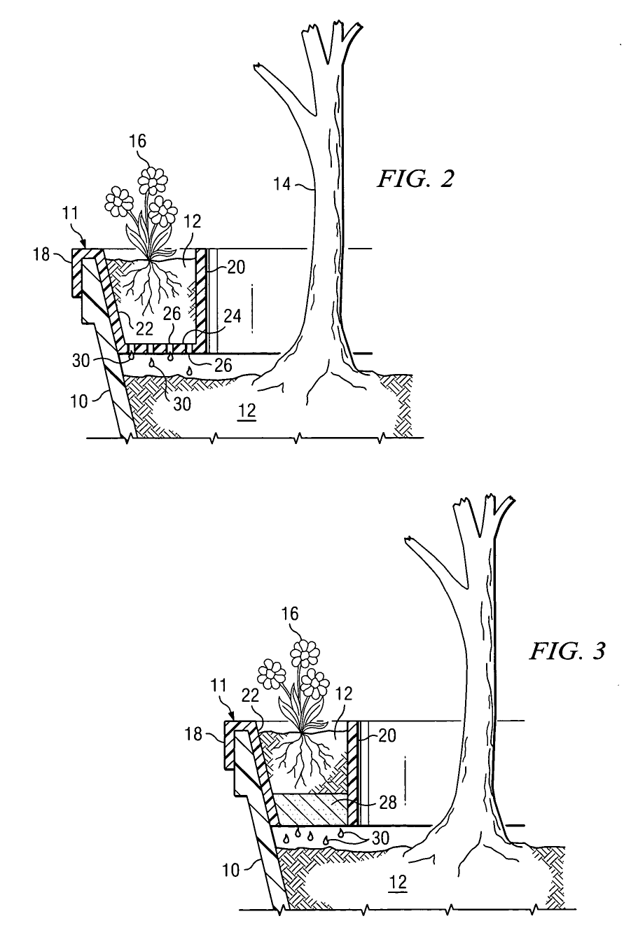

Turning to FIG. 2, a cross-sectional view of the present invention is illustrated. PPD 11 sits atop the upper edge of pot 10. Pot 10 contains planting medium 12 and first plant 14. PPD 11 comprises retaining clip 18, outer wall 22, floor 24, and inner wall 20. PPD 11 contains a U-shaped channel formed by outer wall 22, floor 24, and inner wall 20. The U-shaped channel is filled with planting medium 12 so that at least one second plant 16 may be planted in PPD 11. Floor 24 contains a plurality of small holes 26. When second plant 16 is watered by a person, any excess water 30 passes through planting medium 12 and drips through holes 26 in floor 24. Holes 26 are large enough to allow water 30 to drain out of planting medium 12, but small enough to prevent planting medium 12 from falling out of PPD 11. In an alternate embodiment, holes 26 may be connected by channels (not shown) in floor 24 to facilitate distribution of water within PPD 11. Such channels may run in concentric circles that connect all of holes 26 in the circle. In a further alternate embodiment, channels in concentric circles that connect all of holes 26 in the circle are connected by radial channels connecting opposite holes in adjacent circles. In a further alternate embodiment, a single spiraling channel connects only holes 36 in the path of the spiraling channel. Persons skilled in the art are aware of various methods for facilitating distribution of water by holes 26 within PPD 11.

Turning to FIG. 3, a cross-sectional view of an alternative embodiment of the present invention is illustrated. As with the embodiment illustrated in FIG. 2, PPD 11 sits atop pot 10 containing planting medium 12 and first plant 14. However, in the alternative embodiment illustrated in FIG. 3, PPD 11 comprises retaining clip 18, outer wall 22, semi-permeable material 28, and inner wall 20. Semi-permeable material 28 is a material which is slightly porous so that smaller sized particles flow through the material, but larger sized particles do not. Semi-permeable materials are well known in the arts of reverse osmosis, water filtration, and gas separation. The composition of semi-permeable material 28 will vary from application to application depending on the desired flow rate of water 30 through semi-permeable material 28. For example, if it is desirable for planting medium 12 in PPD 11 to remain relatively moist, a material with less porosity may be selected. However, if it is desirable for planting medium 12 in PPD 11 to be relatively dry, a material with greater porosity may be selected. Persons of ordinary skill in the art are aware of the various material compositions of materials and the porosity associated with each different material composition.

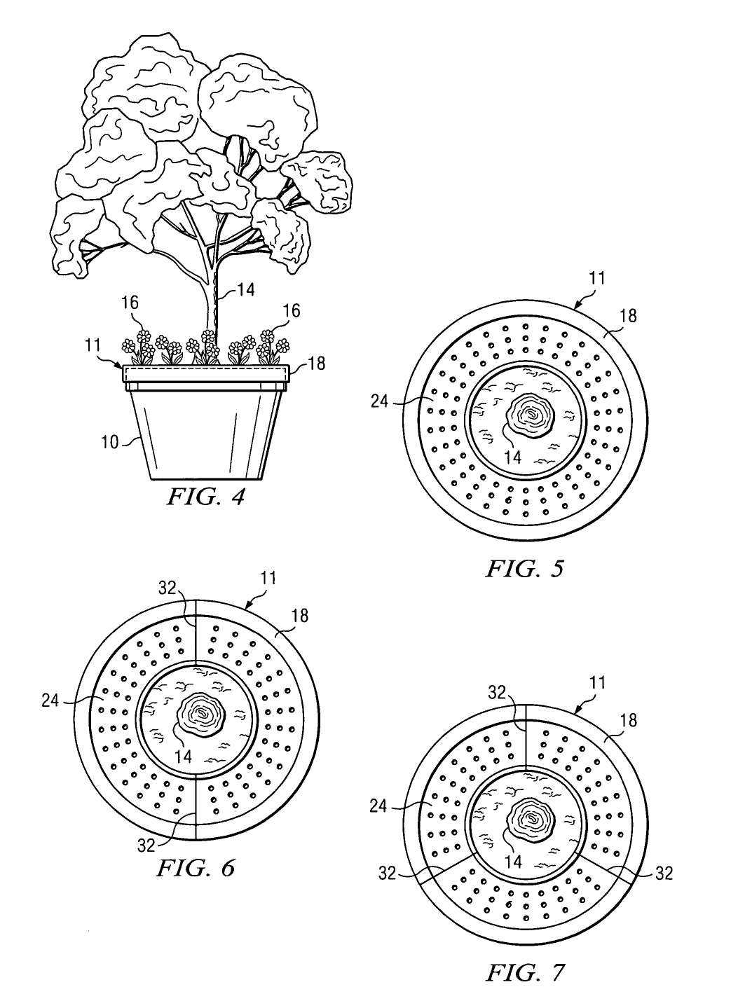

Turning to FIG. 4, an elevation view of the present invention is illustrated. PPD 11 sits atop the upper edge of pot 10. First plant 14 is planted in pot 10. A plurality of second plants 16 are planted in PPD 11. As can be seen in FIG. 4, PPD 11 with second plant 16 adds to the aesthetic beauty of pot 10 and first plant 14. Second plant 16 may be a flower, as illustrated in FIG. 4, or may be a bush, ivy, or other type of plant. Use of an ivy or similar plant can be used such that the ivy drapes over the outside of PPD 11 and conceals retaining clip 18.

Turning to FIGS. 5-7, the plan views of several different embodiments of the present invention are illustrated. In FIGS. 5-7, PPD 11 is shown without planting medium 12 or second plant 16. In FIG. 5, PPD 11 is shown of unitary construction such that there is a single U-shaped channel around the periphery of first plant 14. However, as illustrated in FIG. 6, PPD 11 may contain a plurality of partitions 32. Partitions 32 are vertical walls in the U-shaped channel that separate PPD 11 into two semicircular sections. The embodiment in FIG. 6 is useful when first plant 14 is larger than the empty space within PPD 11. Thus, a person may remove one of the two semicircular sections of PPD 11 from the pot without the planting medium and second plants in the remaining semi-circular section of PPD 11 falling into the pot 10. Additionally, the various sections of PPD 11 can be configured with a connection device, such as a clip or other interlocking mechanism, to secure one section of PPD 11 to another.

In addition to the embodiments illustrated in FIGS. 5-7, PPD 11 may be embodied in a plurality of shapes other than circular. For example, PPD 11 may be linear, triangular, square, hexagonal, or any other shape of a pot as determined by a person of ordinary skill in the art.

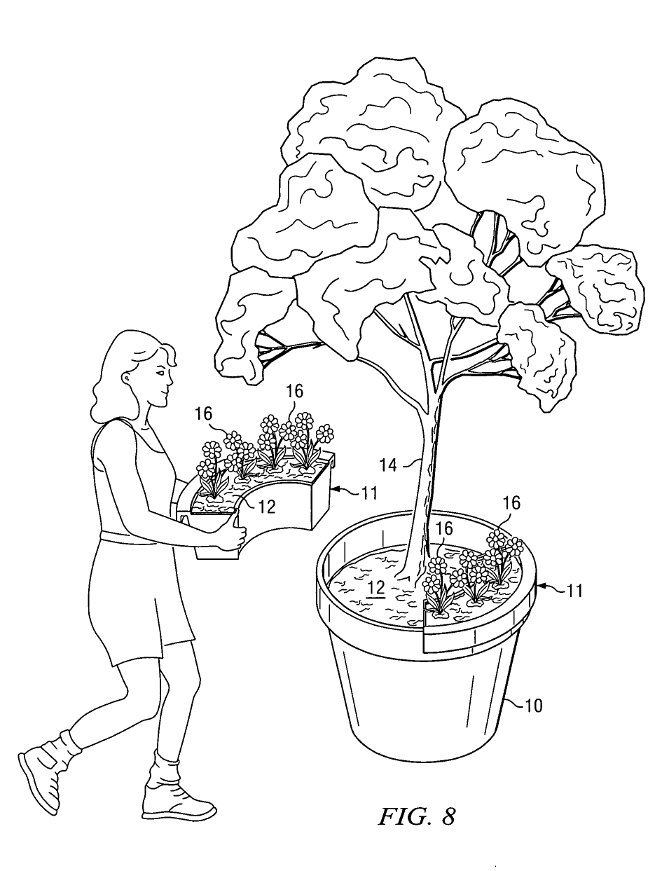

As part of the invention, PPD 11 may be constructed with as many partitions 32 as are required by the user. FIG. 7 illustrates PPD 11 with three partitions 32. The multiple sections created by partitions 32 allow the user to plant a plurality of different types of second plants in the different sections. Moreover, as illustrated in FIG. 8, the user may choose to utilize only one of the sections of PPD 11 to create a partial peripheral planting device, rather than completely surrounding the perimeter of first plant 14. This utilization of PPD 11 is preferable when the pot is in the former of a room and there is no need to locate second plants on the backside of the pot (i.e. in the corner of the room behind the pot). The multiple sections of PPD 11 also allow the user to substitute one section for another as the seasons change. In other words, the multiple sections of PPD 11 allow the user to remove one section of PPD 11, place that section in a greenhouse, and place a new section of PPD 11 containing a different second plant where the first section of PPD 11 was. Thus, a user can replace a portion of the second plants without the need to dig up or re-plant the second plants.

With respect to the above description, it is to be realized that the optimum dimensional relationships for the parts of the invention, to include variations in size, materials, shape, form, function and manner of operation, assembly and use, are deemed readily apparent and obvious to one of ordinary skill in the art, and all equivalent relationships to those illustrated in the drawings and described in the specification are intended to be encompassed by the present invention. The novel spirit of the present invention is still embodied by reordering or deleting some of the steps contained in this disclosure. The spirit of the invention is not meant to be limited in any way except by proper construction of the following claims.

What is claimed is:

1. An apparatus comprising:
a pot containing a first plant;
a planting device located on the upper edge of the pot;
wherein the planting device contains a channel for a second plant; and
wherein the planting device contains a mechanism which allows water to pass from the planting device into the pot.

2. The apparatus of claim 1 wherein the planting device is secured to the pot by a retaining clip.

3. The apparatus of claim 1 wherein the mechanism is a hole in the floor of the planting device.

4. The apparatus of claim 1 wherein the mechanism is a semi-permeable material.

5. The apparatus of claim 1 wherein the planting device is located along the upper perimeter of the pot.

6. The apparatus of claim 1 wherein the planting device is located along a portion of the upper perimeter of the pot.

7. The apparatus of claim 1 wherein the planting device comprises a plurality of sections, each section located on a portion of the upper perimeter of the pot.

8. The apparatus of claim 7 wherein one section can be removed while another section remains on the pot.

9. The apparatus of claim 7 wherein the sections connect together using a connection device.

10. An apparatus for locating a plurality of second plants around a first plant, the apparatus comprising:
a channel containing a planting medium and the plurality of second plants planted in the planting medium;
a retaining clip attached to the channel, the retaining clip operable to secure the channel to a pot; and
a device for transferring water from the channel to a pot containing the first plant.

11. The apparatus of claim 10 wherein the device is a hole in the floor of the planting device.

12. The apparatus of claim 10 wherein the device is a semi-permeable material.

13. The apparatus of claim 10 wherein the apparatus is located along the upper perimeter of the pot.

14. The apparatus of claim 10 wherein the apparatus is located along a portion of the upper perimeter of the pot.

15. The apparatus of claim 10 wherein the apparatus further comprises a plurality of sections, each section located on a portion of the upper perimeter of the pot.

16. The apparatus of claim 15 wherein one section can be removed while another section remains on the pot.

17. The apparatus of claim 15 wherein the sections connect together using a connection device.

18. The apparatus of claim 10 wherein the channel is circular in shape.

19. The apparatus of claim 10 wherein the channel is shaped as a section of a circle.

20. The apparatus of claim 10 wherein the channel is straight.

21. An apparatus for watering a first plant in a first plant container having an upper edge comprising:
a first semi-circular component removably engaged to the upper edge; and
a second semi-circular component removably engaged to the upper edge;
wherein the first semi-circular component and the second semi-circular component each have a retaining clip, an inner wall, an outer wall, and a floor having a plurality of holes;
wherein the first semi-circular component and the second semi-circular component contain a planting medium for a plurality of second plants; and
wherein when water is added to each semi-circular component, the water will pass through a planting medium and through the holes.
